(19) United States
(12) Patent Application Publication
(10) Pub. No.: US 2023/0303902 A1
(43) Pub. Date: Sep. 28, 2023

(54) A BIODEGRADABLE HEAT-ABSORBING COMPOSITION

(71) Applicant: SOLUBLUE LTD, London (GB)

(72) Inventor: Ayca DUNDAR FIELD, Cambridge (GB)

(21) Appl. No.: 18/023,312

(22) PCT Filed: Aug. 26, 2021
(86) PCT No.: PCT/GB2021/052217

§ 371 Date: Feb. 24, 2023

(30) Foreign Application Priority Data
Aug. 26, 2020 (GB) 2013317.9

(51) Int. Cl. C09K 5/06

(52) U.S. Cl. CPC C09K 5/063

(57) ABSTRACT

This invention relates to a biodegradable heat-absorbing hydrogel composition, wherein the heat-absorbing hydrogel composition comprises a seaweed extract in an amount of 1-10% by weight and water in an amount of 85-99% by weight, based on the total weight of the composition. The invention also relates to: products, including heat-absorbing pads, formed from the composition, a method of dissolving, composting and biodegrading the composition or the products, a method of producing the composition and the products, and a method of cooling using the composition.

### TECHNICAL FIELD

This invention relates to a biodegradable heat-absorbing composition. The invention also relates to: products, including heat-absorbing pads, formed from the composition, a method of dissolving, composting and biodegrading the composition or the products, a method of producing the composition and the products, and a method of cooling using the composition.

### BACKGROUND

Heat-absorbing pads, sometimes referred to generically as ice packs or cooling pads, are used for many purposes including cooling enclosed areas, and cooling surfaces by direct contact. They are often used to maintain products below ambient temperature for prolonged periods of time either in addition to, or more commonly, in the absence of, powered cooling systems such as refrigeration units. Heat-absorbing pads are frequently used in transportation and cold-storage of food and medical equipment.

In terms of food preservation, lowering the ambient temperature helps food stay fresh for longer by slowing bacterial growth and therefore inhibiting spoilage. For medical purposes, heat-absorbing compositions can be used to keep temperature-sensitive drugs and treatments cold, while pads formed of a heat-absorbing composition can be used to alleviate bruising, swelling and cuts by lowering the temperature of the tissue through contact thereby reducing inflammation.

Current heat-absorbing compositions come in different forms and with different chemical structures. Some make use of an endothermic chemical reaction that leads to a cooling effect. Although these materials are generally single use and can get very cold at the onset of the reaction. Many heat-absorbing compositions comprise phase-change materials. A phase change material (PCM) is generally a substance with a high latent heat capacity. Latent heat is the energy required to convert a solid into a liquid, or a liquid into a vapour without a change in its temperature. PCMs latent heat storage can be achieved through solid-solid, solid-liquid, solid-gas and liquid-gas phase changes. Water is an example of a phase change material. Commercial heat-absorbing materials for PCMs generally rely on the solid-liquid phase change. Commercial PCMs may be formed of a wide-range of materials, classified into three main groups: organic PCMs are based on organic materials, i.e. comprised primarily of carbon and hydrogen, such as paraffin; inorganic PCMs are based on inorganic salt hydrates, such as sodium acetate hydrate or sodium sulfate decahydrate; and eutectic PCMs, generally based on salt-water solutions.

Examples of commercially available PCMs are sodium sulfate decahydrate (Na₂SO₄·10H₂O); PureTemp™ 29 (PureTemp); Climsel™ C28 (Climator); Climsel™ C32 (Climator); Paraffin 18-Carbons and Paraffin 19-Carbons.

PCMs have a high capacity for heat absorption. In addition, the heat absorption capacity of the PCM is regenerative, for example by cooling the material via refrigeration; therefore the material may be used repeatedly without loss of function.

This repeated use has been a goal of many prior art systems which means that the focus has not been on longevity and not how to dispose of the materials at end-of-life.

For example, petroleum-based products degrade slowly. This means that paraffin PCMs may take years, or decades, to fully decompose. These products will have long-term effects on the environment since paraffins, and other petroleum-based products, are known to be carcinogenic and are toxic to plants and wildlife. (Warg, E.; “Biodegradeability of phase change materials; Entropy Solutions”, 2015).

Biodegradability analyses are not performed on salt hydrate PCMs because the salt compounds in those PCMs will dissociate into their respective ions while in the liquid phase. This does not mean that salt hydrate PCMs are necessarily safe for the environment. Salt hydrates have corrosive characteristics and are known to be toxic to plants and wildlife. (Warg, E., ibid).

Biobased PCMs such as PureTemp™ 29 would appear to biodegrade more quickly, however, the PCM makes use of vegetable bio-based products such as palm oil which has detrimental social and environmental impact (see for example: https://en.wikipedia.org/wiki/Social_and_environmental_impact_of_palm_oil; accessed 14 Aug. 2020).

Furthermore, biobased, and a number of non-biobased cooling compositions, for example, PCMs including water and/or water-based PCMs, are liquid at typical room temperatures and therefore have no structural integrity. These cooling compositions must incorporate some sort of microencapsulation, film or hard shell, often made of plastic or other non-biodegradable material, surrounding the heat absorbing material for use. In addition, the heat-absorbing composition may contain additives such as silica gels, organic hydrocolloid or anti-freeze liquids which do not biodegrade easily and/or are harmful to the environment or animals if exposed.

There is a general desire to move away from products that are not easily biodegradable and/or contain plastics derived from petroleum which have a high environmental impact both during production, and in the disposal stream after use. This is particularly pertinent for single-use products that have a very limited lifespan.

Almost 90% of the cooling pads that are produced today are used only once, often over a short time period such as the time taken to transport a product, or to cool an injury, and then thrown away.

There is a growing environmental concern for governments, consumers, heat-absorbing composition producers and other stakeholders. Thus, there remains a need for a fully, and readily biodegradable and compostable/home compostable heat-absorbing composition and products that are formed from environmentally benign materials that quickly and fully biodegrade in the environment or in waste streams without, or with only minimal, harm to the environment or ecosystems. Suitably, the time for biodegradation is better matched to the timescale of use (specifically, single-use), whilst still providing at least one of the desirable material properties of conventional cooling pads mentioned above.

### SUMMARY OF INVENTION

In a first aspect, the invention provides a heat-absorbing hydrogel composition comprising a seaweed extract in an amount of 1-10% by weight and water in an amount of 85-99% by weight, based on the total weight of the composition. The term ‘heat-absorbing’ being interchangeable with ‘cooling’ in accordance with the definition herein. Suitably, the seaweed extract in present an amount of 1.3-8% by weight and water in an amount of 85-98.7% by weight.

In embodiments, the composition consists essentially of the seaweed extract and water. Suitably, the composition consists of the seaweed extract and water. Suitably, the weight percentages of the seaweed extract and water total 100% by weight of the total weight of the composition.

In embodiments, the seaweed extract is selected from the group consisting of: a carrageenan; agar; alginate; and a mixture thereof. Suitably, the seaweed extract is a carrageenan. Suitably, the carrageenan is carrageenan kappa.

In embodiments, the composition is a phase change material (PCM). As the composition of the present invention is cooled to below 0° C. then it starts to crystallise (i.e. changes phase from a solid gel to a solid semi-crystalline material). Since the composition is denser than water, it would be expected that the crystallisation temperature would be below 0° C. Suitably, the phase change material undergoes a phase transition at from approximately −5° C. In embodiments, typical phase transition temperatures for the compositions of the present invention are as follows:
0° C. and below is solid semi-crystalline;
0° C. to 50° C. solid gel; and/or
50° C. and above liquid gel.

In embodiments, the composition lacks one or more of the group consisting of: a starch; xanthan gum, gum arabic, carrageenan iota; agar; alginate; and chitosan.

In embodiments, the composition is fully biodegradable. Suitably, the composition:
a) fully biodegrades in less than six months in an external, non-industrial environment;
b) fully biodegrades in an aerobic and/or anaerobic atmosphere; and/or
c) is fully compostable in less than six months in a domestic compost heap.

In embodiments, the composition is mouldable.

In embodiments the composition further comprises one or more additives. Suitably, the one or more additives are present in no greater than 10% by weight of the total weight of the composition. Suitably, the one or more additives are selected from the group consisting of: salt; and glycerol. Suitably, the salt is selected from the group consisting of: sea salt; table salt; sodium chloride; and potassium chloride.

In a second aspect, the invention provides for a product formed from the heat-absorbing hydrogel composition of the first aspect. Suitably, the product is a heat-absorbing pad or solid or hollow block.

In embodiments, the product has a working temperature of between −60° C. to 50° C. In further embodiments, the product has a three-dimensional self-supporting structure maintaining its shape and integrity throughout the working temperature. In further embodiments, the product is stable through at least one freeze-thaw cycle. In further embodiments, the composition in the product has no external coating or structure formed of another material for use.

In a third aspect, the invention provides for a method of producing the heat-absorbing hydrogel composition of the first aspect, the method comprising the steps of:
a) contacting the seaweed extract with water to form a seaweed extract hydrogel;
b) heating the seaweed extract hydrogel to form a hydrogel; and
c) allowing the mixture to cool in order to form the composition.

In embodiments, step (a) comprises heating the mixture of the seaweed extract in water to a temperature in the range of approximately 70° C. to approximately 100° C. to form the seaweed extract hydrogel.

In embodiments, the method comprises the steps (a) to (c) of the method of producing a composition of the third aspect, and between steps (b) and (c) the additional step of: moulding the mixture into a shape or a three-dimensional form of a product. Suitably, the three-dimensional form encloses a space suitable for containment of liquids and/or solids. Suitably, the space contains water.

In a fourth aspect, the invention provides a method of dissolving the composition of the first aspect, or the product of the second aspect, the method comprising the step of contacting the composition or product with liquid water. Suitably, the liquid water is at a temperature of at least 70° C. or higher for at least 1 hour.

In a fifth aspect, the invention provides a method of industrial biodegradation of the composition of the first aspect, or the product of the second aspect, the method comprising the step of exposing the composition or product to conditions in which the rate of biodegradation is increased. Suitably, the conditions are selected from the group consisting of: heating; exposure to water; exposure to microorganisms; enzymes; chemical breakdown; mechanical breakdown; and combinations thereof.

In a sixth aspect, the invention provides a method of composting the composition of the first aspect, or the product of the second aspect, the method comprising the step of exposing the composition or product to conditions in which the composition or product degrades to form compost or material suitable for use in compost or as an additive to soil.

In a seventh aspect, the invention provides a method of cooling an enclosed space (indirect cooling when the compositions cools the air in an enclosed space which in products are stored/kept) or a surface (direct cooling where composition directly contacts an item to be cooled), wherein the method comprises cooling the composition of the first aspect or the product of the second aspect and then placing the composition or product or in the enclosed space or in contact with the surface. Suitably, the surface is the skin of a human or animal. Suitably, the surface is the surface of fresh produce. Suitably, the enclosed space contains fresh produce. Suitably, the fresh produce is selected from the group consisting of: fruits; vegetables; meat and dairy products. Cooling of fresh produce either directly or indirectly, lowers bacterial activity and increases shelf-life of fresh food.

Suitably, the composition or product is cooled to below the freezing (or crystallisation, or phase change) point of the composition or product prior to use.

In an eighth aspect, the invention provides for the use of the composition of the first aspect, or the product of the second aspect, as a heat-absorbing block or a heat-absorbing pad, or as a coating or case for a heat-absorbing block or a heat-absorbing pad.

### BRIEF DESCRIPTION OF THE DRAWINGS

One or more embodiments of the invention will now be described, by way of example only, with reference to the accompanying drawings, in which:

FIG. 1 shows a heat-absorbing pad formed of the composition in accordance with an embodiment of the invention having a weight percentage (%) of the total composition (CK extract/water): 5.6/94.4 at 25° C. that was previously frozen to −27° C. The material maintains structural integrity having a solid gel structure.

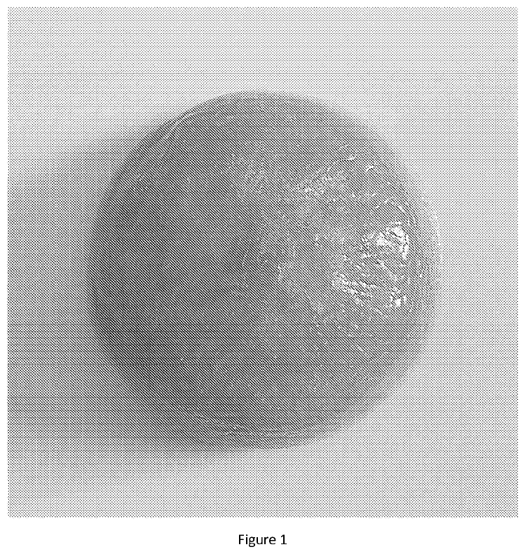

FIG. 2 shows (a) a heat-absorbing pad formed of the composition in accordance with an embodiment of the invention of the same composition as that of the pad of FIG. 1 at room temperature; and (b) having been frozen in a domestic freezer.

FIG. 3 shows (a) the pad as shown in FIG. 2(b) being conveniently held in (a) a plan view; and (b) a side view, ready for application to the skin as a cooling pad.

FIG. 4 shows the pad of FIGS. 2 and 3 being applied directly to the skin for cooling.

### DEFINITIONS

For convenience, before further description of the present disclosure, certain terms employed in the specification, and examples, are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles ‘a’, ‘an’ and ‘the’ are used to refer to one or to more than one (i.e. to at least one) of the grammatical object of the article.

As used herein, the term ‘comprising’ means any of the recited elements are necessarily included and other elements may optionally be included as well. ‘Consisting essentially of’ means any recited elements are necessarily included, elements which would materially affect the basic and novel characteristics of the listed elements are excluded, and other elements may optionally be included. ‘Consisting of’ means that all elements other than those listed are excluded. Embodiments defined by each of these terms are within the scope of this invention. The term ‘comprising’, when used in respect of certain components of the composition, should be understood to provide explicit literal basis for the term ‘consisting essentially of’ and ‘consisting of’ those same components.

As used herein, the term ‘heat-absorbing’ means a material that is capable of absorbing heat energy. Suitably, the term refers to the ability of a material to absorb heat after being cooled or chilled to below ambient temperature. In embodiments, the term may be used synonymously with ‘cooling’, for example a heat-absorbing composition or pad could be referred to as a cooling composition or pad, or a composition or pad capable of absorbing heat or cooling a volume in which it is enclosed, or a surface it is in contact with. The term ‘heat-absorbing’ in reference to a material or composition does not exclude the ability of that material to emit heat either on cooling on when in an environment at a temperature less that itself, or after being warmed to above ambient temperature.

As used herein, the term ‘biodegradable’ means capable of being chemically and/or physically broken down in nature and/or by the action of living things. The term is used herein to refer to compositions, or components within compositions, that naturally break down to innocuous constituents in water or aqueous, or wet environments, typically through the action of microorganisms such as bacteria or fungi. The composition may comply with one or more of European standard EN 13432, OECD 301, OECD 302, OECD 306, ASTM D58864, ISO 14583 (or equivalents), or more generally that 90% of the material disintegrates to particle fragments having a size of no more than 2 mm after twelve weeks and biodegrades by at least 90% after six months (laboratory test method EN 14046). The term ‘hyper biodegradable’, as defined herein, may be used to refer to a material that has a particularly fast rate of biodegradation, for example, less than 6 months, suitably less than 3 months, to fully biodegrade in a natural, non-adapted environment, or waste stream. In this context the term ‘nature’ or ‘natural’ refers to a non-industrial environment and/or an environment that is not adapted to promote biodegradation, such as the open air or a domestic compost heap.

As used herein, the term ‘compostable’ means capable of being broken down in nature and/or by the action of living things for use as compost. Suitably, the term ‘compostable’ may be used to refer to compositions or products that may be acceptably added to a composting site. The term ‘home compostable’, may be used to refer to compositions or products that may be acceptably composted in a domestic environment, for example, added to a compost heap established in a domestic garden. The term may mean a plastic that conforms to the Australian norm AS 5810 “Biodegradable plastics—biodegradable plastics suitable for home composting”; the Belgian certified TUV OK compost home certification scheme, requiring at least 90% degradation in 12 months at ambient temperature; and/or the French standard NF T 51-800 “Plastics - Specifications for plastics suitable for home composting”. The term ‘industrially compostable’ may be used to refer to compositions or products that may be acceptably added to an industrial composting waste stream. An industrial compositing waste stream may, for example, involve an active compositing stage followed by curing. The active compositing phase typically lasts a minimum of 21 days and maintains a temperature in the compost heap of approximately 50° C. to 60° C. throughout this period. For hygienisation purposes, temperatures may remain above 60° C. for at least one week in order to eliminate pathogenic microorganisms. During the curing phase the rate of decomposition slows and the temperature lowers to <40° C. with synthesis of humic substances.

As used herein, the term ‘non-hazardous’ means not toxic or presenting a risk to people and animals, or the environment. In terms of chemical compounds, non-hazardous may mean complying with any one or more of EC Regulation No 1907/2006, EC Regulation No 1272/2008, REACH Directive 1999/45/EC, No 76/769/EEC, European Council Directive 793/93 and 91/155/EEC, 93/67/EEC or 67/548/EEC; or achieving a toxicity category IV (practically non-toxic and not an irritant) according to Title 40 of the United States Code of Federal Regulations (156.62), OECD 201, OECD 202, OECD 203, or equivalents thereof.

As used herein, the term ‘seaweed’ refers to the commonly used term for several groups of multicellular algae typically found in or close to the sea or bodies of fresh water. Types of seaweed include Rhodophyta (red), Phaeophyta (brown) and Chlorophyta (green) macroalgae. Many of the brown algae are referred to simply as kelp.

As used herein, the term ‘seaweed extract’ refers to a separated or isolated component or constituent part of seaweed. Suitably the method of separation or isolation is via chemical or physical extraction (i.e. gel press or precipitation in alcohol and alkaline hydrolysis). For example, the seaweed extract may be obtained by crushing of the seaweed plant, or part thereof, followed by filtration to remove the solid seaweed residue material; or alternatively, washing the seaweed with a suitable solvent, for example an alkaline aqueous solution, and collecting the desired extract as the, or part of the, insoluble matter that remains. The extract may be subject to further purification/separation steps. Examples of seaweed extract in accordance with the meaning herein are the extracts carrageenan, agar and alginate, suitably carrageenan.

As used herein the term ‘carrageenan’ refers to a family of linear sulphated polysaccharides extracted from red seaweed. There are three main varieties of carrageenan, which differ in their degree of sulfation. Carrageenan kappa has one sulfate group per disaccharide, carrageenan iota has two, and carrageenan lambda has three.

### DETAILED DESCRIPTION

This invention generally relates to a biodegradable heat-absorbing, or cooling, hydrogel composition. In embodiments, the composition is suitable for use as a heat-absorbing pad, often generically termed a cooling pad or an ‘ice’ pack.

The biodegradable heat-absorbing hydrogel composition of the present invention decomposes fully and rapidly (hyper biodegradable) in the environment, particularly in aqueous or otherwise non-dry environments of various kinds, or in waste streams, yet maintains one, more or all of the benefits of petroleum-based plastics or plant-based bioplastics, during its lifetime of use.

The biodegradable heat-absorbing hydrogel composition of the present invention retains structural integrity at room temperature, when cooled, and after thawing meaning it may be used without any external coating or structure. The structure of the material at room temperature is that of a solid gel (hydrogel). In addition, it may be used as a coating or surround for other heat-absorbing, or cooling, compositions, such as water.

Without wishing to be bound by theory, it is thought the composition of the present invention is particularly useful as a heat-absorbing composition through its ability to use the phase-change properties of the high water content to provide a particularly high latent heat in changing from ice to liquid water on warming (cooling its surroundings or contacting surface).

The heat-absorbing composition of the present invention generally comprises a seaweed extract and water.

In embodiments, the seaweed extract may be a carrageenan, agar, or a mixture thereof. The family of carrageenan compounds and agar are well-known in the food, pharma and personal care product fields; however, they are chemically distinct. Carrageenans comprise repeat units of β-D-galactose-cc-D-galactose, while agar comprises repeated β-D-galactose-α-L-galactose. Suitably, the seaweed extract used in the composition of the present invention is a carrageenan. More suitably, the carrageenan may be carrageenan kappa.

It is contemplated that any seaweed extract may be useful in the present invention. As would be expected however, while carrageenans, agar and other seaweed extracts have a common source (seaweed), and related chemical structures, each substance has differing properties when forming hyper biodegradable replacement materials therefrom. For example, carrageenans, in particular, carrageenan kappa displays surprisingly beneficial mechanical material properties, and water absorption properties compared to agar and other seaweed extracts.

In embodiments, the heat-absorbing composition comprises only a seaweed extract, such as a carrageenan, with the remainder of the composition being water. In other words, and as defined herein, the composition may consist of a seaweed extract and water. In other words, the weight percentages of these components may add up to 100% by weight based on the total weight of the heat-absorbing composition.

In embodiments, it is contemplated that other minor additives may be included that may provide one or more benefits without detrimentally affecting the overall properties of the composition. In other words, and as defined herein, the composition may consist essentially of a seaweed extract and water. The term ‘minor additives’ or ‘additives’ is intended to relate to additives other than a seaweed extract that may be present in the composition in an amount of 20 wt % or less. Suitably, less than 15 wt %, 10 wt %, 5 wt %, 2 wt %, 1 wt %. All weight percentages are based on the total weight of the composition. In other words, the weight percentages of the seaweed extract, water and the minor additive(s) may add up to 100% by weight based on the total weight of the composition.

The additives or minor additives may be, although not limited to: inorganic salts such as potassium chloride, calcium chloride, sea salt or table salt; sawdust, paper, hemp fibre, cork; calcium carbonate; glycerine; apple puree; starch; montmorillonite (MMT); cinnamon bark oil; soybean oil; glycerol; silver nanoparticles; grapefruit seed extract; zataria multifloro essential oil; nonoclay or clay mineral; polyethylene glycol (PEG); chitin; arabinoxylan; banana powder; gelatin; titanium oxide nanoparticles; hydrocolloids, xanthan gum, gum arabic, MC, CMC, HPMC. Alternatively, in embodiments, the composition of the present invention, and products formed therefrom, may lack any minor additives, including but not limited to one or more of those listed above.

In embodiments, the composition may comprise a salt, more suitably an alkali metal salt or an alkaline earth metal, even more suitably a lithium, sodium, calcium or a potassium salt. Most suitably, the composition may comprise a potassium salt. In embodiments, the potassium salt is potassium chloride. Suitably, the composition may comprise the salt in an amount in the range between 0.1-5% by weight, more suitably in the range between 0.5-3% by weight, even more suitably in the range between 0.5-1.5% by weight. Suitably, the salt may be present in the composition in an amount of at least 0.1% by weight, 0.2% by weight 0.3% by weight, 0.4% by weight, 0.5% by weight, 0.6% by weight, 0.7% by weight, 0.8% by weight, 0.9% by weight, 1.0% by weight, 2.0% by weight, 3.0% by weight, 4.0% by weight or above. Suitably the salt may be present in the composition in an amount of at most 5.0% by weight, 4.0% by weight, 3.0% by weight, 2.0% by weight, 1.9% by weight, 1.8% by weight, 1.7% by weight, 1.6% by weight, 1.5% by weight or below; all weight percentages are based on the total weight of the composition. Without wishing to be bound by theory, it is believed that the inclusion of such salts can increase the rigidity of the resulting composition and products formed therefrom.

In embodiments, the composition may comprise vegetable oils such as glycerol. More suitably, the composition may comprise vegetable oils such as glycerol in an amount in the range of 0.1-10% by weight, even more suitably in the range of 1-5% by weight, more particularly 1.5-2.5% by weight, all weight percentages are based on the total weight of the composition. Without wishing to be bound by theory, it is believed that the inclusion of vegetable oils such as glycerol can increase the flexibility of the resulting products.

In embodiments, the heat-absorbing composition may comprise the seaweed extract in an amount of 1% to 10% by weight, suitably 1.3% to 10% by weight, suitably 2% to 10% by weight, suitably 2% to 8% by weight. Suitably 2% to 6% by weight. Suitably the heat-absorbing composition may comprise the seaweed extract in an amount of at least 1.0% by weight, 1.1% by weight, 1.2% by weight, 1.3% by weight, 1.4% by weight, 1.5% by weight, 1.6% by weight, 1.7% by weight, 1.8% by weight, 1.9% by weight, 2.0% by weight, 2.1% by weight, 2.2% by weight, 2.3% by weight, 2.4% by weight, 2.5% by weight, 2.6% by weight, 2.7% by weight, 2.8% by weight, 2.9% by weight, 3.0% by weight, 3.1% by weight, 3.2% by weight, 3.3% by weight, 3.4% by weight, 3.5% by weight, 3.6% by weight, 3.7% by weight, 3.8% by weight, 3.9% by weight, 4.0% by weight, 4.1% by weight, 4.2% by weight, 4.3% by weight, 4.4% by weight, 4.5% by weight, 4.6% by weight, 4.7% by weight, 4.8% by weight, 4.9% by weight, or 5.0% by weight. Suitably the composition may comprise the seaweed extract in an amount of at most 10.0% by weight, 9.9% by weight, 9.8% by weight, 9.7% by weight, 9.6% by weight, 9.5% by weight, 9.4% by weight, 9.3% by weight, 9.2% by weight, 9.1% by weight, 9.0% by weight, 8.9% by weight, 8.8% by weight, 8.7% by weight, 8.6% by weight, 8.5% by weight, 8.4% by weight, 8.3% by weight, 8.2% by weight, 8.1% by weight, 8.0% by weight; 7.9% by weight, 7.8% by weight, 7.7% by weight, 7.6% by weight, 7.5% by weight, 7.4% by weight, 7.3% by weight, 7.2% by weight, 7.1% by weight, 7.0% by weight. 6.9% by weight, 6.8% by weight, 6.7% by weight, 6.6% by weight, 6.5% by weight, 6.4% by weight, 6.3% by weight, 6.2% by weight, 6.1% by weight, or 6.0% by weight. All weight percentages are based on the total weight of the heat-absorbing composition.

In embodiments, the heat-absorbing composition may comprise 80-99% by weight water, even more particularly 90-98.7% by weight, even more particularly 90-98% by weight all weight percentages are based on the total weight of the heat-absorbing composition. Suitably the heat-absorbing composition may comprise the water in an amount of at least 90.0% by weight, 90.1% by weight, 90.2% by weight, 90.3. % by weight, 90.4% by weight, 90.5% by weight, 90.6% by weight, 90.7% by weight, 90.8% by weight, 90.9% by weight, 91.0% by weight, 91.1% by weight, 91.2% by weight, 91.3. % by weight, 91.4% by weight, 91.5% by weight, 91.6% by weight, 91.7% by weight, 91.8% by weight, 91.9% by weight, 92.0% by weight, 92.1% by weight, 92.2% by weight, 92.3. % by weight, 92.4% by weight, 92.5% by weight, 92.6% by weight, 92.7% by weight, 92.8% by weight, 92.9% by weight, 93.0% by weight, 93.1% by weight, 93.2% by weight, 93.3. % by weight, 93.4% by weight, 93.5% by weight, 93.6% by weight, 93.7% by weight, 93.8% by weight, 93.9% by weight, 94.0% by weight, 94.1% by weight, 94.2% by weight, 94.3. % by weight, 94.4% by weight, 94.5% by weight, 94.6% by weight, 94.7% by weight, 94.8% by weight, 94.9% by weight, or 95.0% by weight. Suitably the heat-absorbing composition may comprise the water in an amount of at most 99.0% by weight, 98.9% by weight, 98.8% by weight, 98.7% by weight, 98.6% by weight, 98.5% by weight, 98.4% by weight, 98.3% by weight, 98.2% by weight, 98.1% by weight, 98.0% by weight, 97.9% by weight, 97.8% by weight, 97.7% by weight, 97.6% by weight, 97.5% by weight, 97.4% by weight, 97.3% by weight, 97.2% by weight, 97.1% by weight, 97.0% by weight, 96.9% by weight. 96.8% by weight, 96.7% by weight, 96.6% by weight, 96.5% by weight, 96.4% by weight, 96.3% by weight, 96.2% by weight, 96.1% by weight, 96.0% by weight, 95.9% by weight, 95.8% by weight, 95.7% by weight, 95.6% by weight, 95.5% by weight, 95.4% by weight, 95.3% by weight, 95.2% by weight, 95.1% by weight, or 95.0% by weight. All weight percentages are based on the total weight of the heat-absorbing composition.

In a specific embodiment of a heat-absorbing composition in accordance with the present invention, the composition may comprise carrageenan kappa in an amount of 1.3-6% by weight, suitably 2-6% by weight; and water in an amount of 94.4-98.7% by weight, suitably 94.4-98% by weight. All weight percentages are based on the total weight of the heat-absorbing composition. In embodiments, the weight percentages of carrageenan kappa and water may add up to 100% by weight based on the total weight of the heat-absorbing composition.

The heat-absorbing composition of the present invention contains significant amounts of water. Without wishing to be bound by theory it is believed that the exceptional biodegradability, or hyper biodegradability, of the composition of the present invention is, at least in part, due to the presence of water which, along with the major components of the composition being a natural food source, encourages and facilitates the growth of the microorganisms such as bacteria or fungi on the composition that that lead to its biodegradation.

The heat-absorbing composition of the present invention comprises significant amounts of water yet retains its shape and structural integrity at room temperature or at typical cooled temperatures of −40° C. to −10° C., suitably −20° C. to −10° C.

In embodiments, the composition may retain its shape and structural integrity at both upper and lower working temperatures, and there between, for example between −40° C. to 55° C. Suitably, between −30° C. to 30° C., or −20° C. to 30° C. Maintaining shape or structural integrity in this context means the composition is sufficiently solid and robust at the upper and lower ranges mentioned above to allow typical use for cooling without additional support, coating or encapsulation with another material or structure.

The consistency of the composition of the present invention is a hydrogel. Hydrogels are network polymeric materials in which the polymer chains are hydrophilic, such that they can associate with large quantities of water without dissolving. The water can be tightly bound to the polymer network or free to move within the polymer network. Hydrogels comprise mechanical properties of rubber elasticity, viscoelasticity, for example, as detailed in Oyen, M. L. (January 2014). “Mechanical characterisation of hydrogel materials”. International Materials Reviews. 59 (1): 44-59. Hydrogels are distinct from other gels or otherwise gelatinous, viscous or thick aqueous solutions or suspensions that may form when polysaccharides or seaweed extracts are mixed with water at below a temperature, for example below 50-70° C. It is a characteristic of the hydrogel of the present invention that it is not soluble in cold water (<50° C.) The composition's high water content has a further advantage of encouraging microorganism growth and thereby promoting rapid (<2 months) and significant biodegradation, for example in urban roadside-type environment, in compost, in waste streams, or in sewers, the sea or rivers.

It would also be expected that the composition of the present invention also disintegrates and/or dissolves in digestive tract fluids. Therefore, in view of the innocuous and food-safe components, it is anticipated that the composition is non-hazardous for human and/or animal consumption, i.e. the material is, in principle at least, edible. As seaweed extract, in particular, carrageenans and agar, for example, are common additives in many food products, it is a feature of the compositions of the present invention that the composition is food safe.

It would also be expected that the composition of the present invention may be disinfected to reduce or eliminate harmful bacteria or viruses. Such disinfection may be by anti-microbial, anti-bacterial, or antiseptic washes or by UV light to render to the composition, and products formed therefore aseptic and/or suitable for medical use.

It is anticipated that the composition may be soluble/dissolves in liquid water at a temperature of 70° C. or more, more particularly 80° C. or less, even more particularly 90° C. or more. The length of time required for dissolution depends at least partially on the form, or shape, and thickness of the material. For example, block material with a volume of approximately 20 mm³ (cubic mm), complete dissolution would be expected within 1 hour at room temperature with continuous mixing.

While the composition of the present invention, or products formed therefrom, exhibit surprisingly beneficial properties in terms of biodegradability in the environment or in water, the compositions, or products formed therefrom, when stored in aseptic and/or dry conditions may exhibit a shelf life prior to use of up to 3 years, more particularly 2-3 years when refrigerated or frozen. If the composition of the present invention is not preserved in cool temperature the shelf life of the composition is reduced, perhaps to around 1 month.

In a further aspect, the invention relates to products comprising or formed from the biodegradable composition described above. In embodiments, the product may be a shaped article, such as a block or a pack, or the product may be a three-dimensionally shaped article to at least partially line, or fill, a container. Suitably the three-dimensionally shaped article may be generally shaped as a planar sheet that may at least partially cover a surface, for example an internal face of a cooler box or container, or as a regular or irregular sphere or spheroid, a cube or cuboid, an ellipsoid, a cylinder, a cone, a prism, a pyramid, or a combination of these. All these shapes could be formed as a solid or have a shape suitable for containment of liquid or other solid materials within. Suitably, when the products are hollow or otherwise have a shape suitable for containment of other liquids or solids, then the other liquids may be additional composition of the present invention, with the same or different proportions of components, or other suitable heat-absorbing materials. The other heat-absorbing materials may be water or other heat-absorbing materials, known or unknown. Suitably, the product may be shaped to increase or maximise surface area for enhanced heat transfer between the product and the environment. The surprising structural rigidity of the and other material properties of the composition make it particularly suited to use in blocks or packs, such as freezer blocks or cooling pads.

In embodiments where the products have a shape suitable for containment of liquid or solid materials, the shape is suitably such that the liquid or solid contained therein is enclosed or encapsulated by the product. Suitably, the liquid or solid is completely encased or encapsulated by the product such that no liquid or solid is lost in use. Suitably, the product in these embodiments is hollow or have a void within such that the liquid or solid may be placed inside, or alternatively, the product is formed in two or more pieces for assembly around the liquid of solid to be contained, Suitably, the product may be similar to a sachet, shaped like a shell or cup with at least one opening such that the liquid or solid can be placed inside before sealing. In all embodiments, where the product encases an additional liquid or solid, the product may have any suitable thickness (minimum distance between two faces), for example, the product may take the form of a pouch or case, alternatively the product may take the form of a coating. The liquid or solid used with the product in these embodiments may be additional composition of the present invention, with the same or different proportions of components, or other suitable heat-absorbing materials. The other heat-absorbing materials may be water or other heat-absorbing materials, known or unknown.

Embodiments where a liquid or solid is encased or encapsulated within the product may exploit advantageous or different properties of the other heat-absorbing materials contained to achieve or modulate the desired properties of the product as a whole, for example using the enhanced latent heat capacity of water within the product increase the overall heat-absorbing properties of the product.

In embodiments, the thickness of the product may be appropriate for the use. Suitably, the products of the invention, when for example the products are biodegradable ice packs, may have a thickness (minimum distance between two surfaces of the product) of 0.2 cm or less. Suitably, the products may have a thickness of at most 10 cm, 9 cm, 8 cm, 7 cm, 6 cm, 5 cm, 4 cm, 3 cm, 2 cm, 1 cm, or 0.5 cm or less. Suitably, the products may have a thickness of at least 0.2 cm, 0.5 cm, 1 cm, 2 cm, 3 cm, 4 cm, 5 cm, 6 cm, 7 cm, 8 cm, 9 cm or 10 cm or more. Each of these thicknesses can be used in three-dimensional products.

In contrast to some heat-absorbing compositions, for example prior art PCMs, which are limited in their structural rigidity and are generally present at room temperature as liquids or mobile hydrogels, encased in coatings, external containers or microencapsulation to provide the required structural rigidity, the composition of the present invention may form a self-supporting structure with the ability to support its own shape and structure through common usage as a cooling aid. The relatively high compressive strength properties of the composition of the present invention allows use of the material to form moulded products i.e. products that form a three-dimensional structure without exterior support or structures. Without wishing to be bound by theory, it is believed the seaweed extract, suitably carrageenan agar and alginate, in particular carrageenan kappa, that provides the surprisingly beneficial properties in terms of structural rigidity and mouldability to the composition.

The composition of the present invention, and products formed thereof may suitably be moulded to show embossed detail present on the mould. Suitably, the embossing can be achieved on the surface of the material composition.

In another surprising benefit of the present invention it has been found that cooling or heat-absorbing pads made from or comprising the composition of the present invention can lead to a lack of, or reduced, condensation on the surface of the cooling pad in use. The hygroscopic nature of the composition means that any moisture condensing on the surface of the pad is absorbed, and retained by, the composition meaning the surface of the pad remains dry to the touch. While this is generally of benefit as it prevents water collecting in containers where the cooling pad is used, or being transferred to the skin. This property may be of particular utility for the storage of food as the environment in which the food is stored becomes less suitable for microorganism growth that is typically responsible for mould growth and decay. This may retard decomposition of the food within the packaging and lengthens the food's shelf life as a result.

In embodiments, the amount of water absorbed by the composition may be at least 1%, 2%, 3% , 4%, 5%, 6%, 7%, 8%, 9%, 10% of the total weight of the composition. Suitably, the amount of water absorbed by the composition may be extended by at least 20%, 30%, 40%, 50%, 60%, 70%, 80%, 90%, 100% or more of the total weight of the composition.

Based on the data provided, it is observed that seaweed-based ice pack material stayed cooler for longer compared to ice covered in plastic film. This property is very advantageous for an ice pack product.

In a further aspect, this invention relates to a method of preparing a composition as defined above, the method comprising the steps of:
(a) contacting and/or mixing a seaweed extract with water, or other suitable polar solvent, to form a seaweed extract mixture;
(b) heating the seaweed extract mixture to form a seaweed extract hydrogel;
(c) allowing the seaweed extract hydrogel to cool in order to form the composition.

The seaweed extract in step (a) may as defined elsewhere herein. Suitably the seaweed extract is a carrageenan or agar. Suitably the seaweed extract is carrageenan kappa.

Suitable polar solvents in step (a) or (b), aside from water, may be any polar solvent that can form suitable hydrogels with the seaweed extract. Suitably, the polar solvent has a boiling point that prevents or retards dehydration of the formulation after moulding, for example the solvent has a minimum boiling point of 75° C. or more. Suitably, the solvent is non-hazardous and not damaging to the environment. Polar solvents in this context may include, but are not limited to, ethanol, methanol, propanol, butanol, and dimethylsulfoxide. The choice of polar solvent may be made based on intended use of the product and any associated chemical risk or health factors.

In embodiments, in step (a) seaweed extract, suitably in powder form, is mixed, or otherwise combined, with cold water to form mixture, this mixture is typically a paste. This paste is then heated, suitably with mixing, to an elevated temperature. On heating, the seaweed extract hydrogel is formed. Suitably, the elevated temperature may be 80° C. or more, more suitably 80-100° C., even more suitably 90-95° C. In embodiments, the paste may be held at the elevated temperature for between approximately 20 minutes and approximately 4 hours. Suitably, heating is for between approximately 1 hour and approximately 3 hours. Most suitably, heating is for approximately 2 hours.

In embodiments, in step (a) the concentration of seaweed extract in the seaweed extract hydrogel may be 1-10% w/v in the seaweed extract hydrogel, even more suitably 1-8% w/v, more suitably 1.3 to 5.6%. In embodiments, after step (a), further water, or other suitable polar solvent as appropriate is added to the hydrogel to achieve the desired viscosity. Suitably the consistency of the seaweed extract hydrogel used in step (b) is a liquid. The total amount of water in the composition may be between 100% to 300% of the original volume of water added in step (a).

In embodiments the heating step (b) may be done with stirring, suitably no stirring or other agitation is required during the heating.

On forming the seaweed extract hydrogel, foaming may occur due to bubble formation in the mixture. Foaming may continue throughout the heating in step (b). Typically, the foaming happens only in step (b). The foam may be removed at any time during or following (b), and removal of the foam formed may be repeated. Suitably, the foam is removed after heating in step (b) is complete. Removal of the foam may be pre-empted by, or conducted concurrently with, degassing of the mixture. Degassing or other forms of removal of bubbles from the solution may be conducted on its own without foam removal. Such degassing may comprise stirring the mixture during heating to encourage release of bubbles from the mixture. Other forms of degassing, such as ultrasonic treatment and vibration, under atmospheric pressure or under reduced pressure (vacuum) may be used instead or in addition and are also contemplated. Suitably, the mixture will be degassed for approximately 2 hours to approximately 8 hours. Suitably, approximately 2 hours to approximately 6 hours. Most suitably, degassing is performed for approximately 3 to approximately 4 hours. Suitably the degassing occurs with or directly after heating in step (b).

The final concentration of the components at the end of step (b) may be in the range of between 1 wt % to 10 wt %, suitably between 1.3 wt % and 6 wt %, suitably between 2 wt % to 6 wt % seaweed extract and in the range of between 90 wt % to 99 wt %, suitably between 94 wt % to 98.7 wt %, suitably 94 wt % to 98 wt % water or other suitable polar solvent. All weight percentages being based on the total weight of the mixture at the end of step (b).

Since there is no drying process, all compositions take the same volume and thickness when the compositions are moulded into the same mould, whether the mixture has high or low viscosity. However, lower viscous composition has low density and weaker (less durable) than the composition that has high viscosity and high density.

In embodiments, the method may comprise, in step (a), and/or (b), the step of adding one or more additives as defined elsewhere herein. The additives may be dyes or pigments. These can give colour to the composition. Other additives may be a salt or glycerol as described above. Suitably, salt or glycerol may be added to the mixture produced in step (b).

In a further aspect, this invention relates to a method of producing a product as defined above. The method comprises steps (a)-(c) as defined above for forming the composition, and, between steps (b) and (c), the step of forming or moulding the mixture in a shape of the product.

The forming step may comprise moulding. Suitably, moulding may comprise casting, extrusion moulding, compression moulding, press-moulding, injection moulding, rotational moulding or slip forming, blow moulding. Most suitably the moulding is press moulding.

The moulding technique may be selected to be suitable for mass manufacturing, for example injection moulding, press moulding, or casting. A particular feature of the present invention is that the composition after preparation is relatively fluid and requires cooling to form a material with the desirable structural properties for a given product. While any aforementioned moulding technique may be adapted to accommodate this, casting and injection moulding have been found to be particularly beneficial.

In embodiments as herein described where products formed from the composition are filled, or encase or encapsulate further liquids or solids that may enhance or modulate the heat-absorbing properties of the product, then these products may be made by any suitable methods as outlined above. In embodiments, a process of extruding a tube of hydrogel where a liquid such as water, is simultaneously injected into the void created and which, when filled is ‘crimped’ and cut (combination of heat and pressure to form weld) into separate sachets of liquid, such as water, is contemplated. In other embodiments, the product may be formed in a suitable shape, for example a shell or clam shape into which liquid or solid is provided and then the product is sealed.

The material is generally added to the mould at above ambient temperature to retain fluidity of the mixture. Suitably the material is added to the mould at approximately 80° C. to 100° C., or more suitably 85° C. to 95° C. In embodiments, the material is added to the mould at approximately 70° C., 75° C., 80° C., 85° C., 90° C., 95° C. or 100° C. Suitably, the material is added to the mould at approximately 90° C. Below 70° C., the material may solidify complicating or preventing suitable moulding.

When the liquid hydrogel cools and solidifies (after an appropriate time), the mould can then be separated, and the material removed without, or with only minimal drying.

In embodiments where the material is at least partially cooled in the mould, the composition is cooled in the mould to ambient temperature. Suitably the composition may be cooled to a temperature below approximately 40° C., and above approximately 0° C. Suitably, the composition may be cooled to a temperature of approximately, or exactly, 30° C., 25° C., 20° C., 15° C., 10° C., or 5° C.

In a further aspect, the invention also relates to a method of dissolving, degrading, biodegrading or otherwise safely decomposing the composition or product of the earlier aspects of the present invention described above. Alongside the material's ability to fully biodegrade rapidly (less than 4-6 months, suitably >2 months) in a range of environments, both naturally occurring and man-made such as industrial composting facility, the option of dissolving the composition in water may be important in respect of the management of waste streams.

Specifically, the ability of the composition to readily dissolve in water may be advantageous in helping to prevent the product-composition from contaminating plastic recycling waste streams if wrongly discarded in a recycling bin by the consumer (the composition is intended for composting waste streams), by facilitation its separation at the point where recyclable plastics are submersed in liquid and washed prior to processing.

In embodiments of the composition, or products derived therefrom, the method of dissolving the composition or products comprises the step of contacting the composition or product with liquid water at a temperature of 70° C. or more, more particularly 80° C. or more, even more particularly 95° C. or more. In this embodiment of the method, the composition may comprise the seaweed extract in an amount of 1-10% by weight, more particularly 1-6% by weight. More particularly, the composition may comprise 90-99% by weight water, even more particularly 94-97% by weight. Suitably, the composition is contacted with the liquid water at a temperature of 90° C. for between 15 to 30 minutes with continuous stirring to effect dissolution.

The ability to dissolve the composition of the present invention, or products derived therefrom, to innocuous, food-safe, water-soluble components has the advantage of providing a simple and reliable waste disposal stream. While the composition and or products will fully and rapidly biodegrade in the environment should this be necessary. The above method provides a means of easy disposal of the composition or products when disposed of through an appropriate managed waste stream. The ability of the composition to dissolve in water dependent on its temperature allows selection of a particular composition for a given use, dependent on the environment, its intended timescale and envisaged waste stream of that use.

### EXAMPLES

### Example 1—Specific method for the preparation of a heat-absorbing composition in accordance with the present invention

Carrageenan Kappa in powder form (30 g) was added to 500 g of water (20° C.) before being mixed for 5 minutes. The resulting paste was warmed to 80° C. to 95° C. by being placed in a hot water bath. As the mixture increased to the desired temperature it became a liquid gel (hydrogel). The mixture was held at 80° C. to 95° C. for 2 hours.

After 2 hours the mixture had the appearance of a liquid gel. Any bubbles formed in the mixture were cleared by degassing which occurred without need for further intervention during heating. During this time, all the bubbles rose to the surface and then the foam was collected.

A biodegradable ice pack product was produced by pouring the hot prepared solution into a mould. and the solution allowed to cool to 25° C. over approximately 5 to 15 minutes, whereupon the hydrogel solidified. The product was then demoulded to leave the desired product as a three-dimensional block.

The resulting packaging is expected to be fully biodegradable, edible and to dissolve in hot water at 50° C. and above. In use, the composition can be cooled to at least −10 to −50° C. whereupon it undergoes a phase change to a solid (freezes) such that the composition may then be used as a single-use biodegradable cooling pack.

### Example 2—Preparation of exemplified compositions

Compositions 1 to 8 in accordance with the present invention were prepared in accordance with the general method of Example 1, replacing and/or adapting the seaweed product and proportions of components as appropriate. Composition 9 which has no seaweed extract content and is essentially water was provided as a control.

A summary of Compositions 1 to 9 is provided in Table 1:

TABLE 1

| | | | | wt % of the total |
|---|---|---|---|---|
| Compo- | Seaweed | | | composition |
| sition | Extract | Weight/gr | Water/gr | (seaweed extract/water) |
| 1 | Carrageenan | 15 | 250 | 5.6/94.4 |
| 2 | Kappa | 15 | 400 | 3.6/96.4 |
| 3 | | 15 | 500 | 3/97 |
| 4 | | 15 | 600 | 2.4/97.6 |
| 5 | | 15 | 1000 | 1.4/98.6 |
| 6 | | 15 | 1200> | 1.2/98.8 |
| 7 | Agar | 15 | 600 | 2.4/97.6 |
| 8 | Carrageenan | 15 | 600 | 2.4/97.6 |
| | Iota | | | |
| 9 | N/A | N/A | 600 | 0/100 |

### Example 3—Mouldability

The ability to mould the exemplified compositions of Example 2 was tested using the following method.

Compositions were cast into a mould when hot. On demoulding the properties of each composition in gel-state could be observed. It was recorded how different compositions were able to be moulded, and the length of time required for solidifying. The results are shown in Table 2:

TABLE 2

| | | Solidifying |
|---|---|---|
| Composition | Mouldability | Time |
| 1 | Y | 10 |
| | | minutes |
| 2 | Y | 10 |
| | | minutes |
| 3 | Y | 20 |
| | | minutes |
| 4 | Y | 45 |
| | | minutes |
| 5 | Y | 75 |
| | | minutes |
| 6 | N | — |
| 7 | Y | 60 |
| | | minutes |
| 8 | N | — |

Compositions 1 to 4 comprising >2 wt % carrageenan kappa all demonstrated good mouldability. Composition 5 demonstrated acceptable mouldability. There was a general trend for shorter solidifying times for higher CK concentration compositions. Compositions that can solidify faster have an advantage by increasing the production speed.

Composition 8 comprising carrageenan iota respectively failed to form a solid hydrogel, neither did CK composition 6 that contained 98.8 wt % water based on the total weight of the composition.

### Example 4—Temperature change

Compositions were prepared comprising same amount of seaweed extracts; carrageenan kappa (CK, or ck) and agar and different amounts of water in order to observe the impact of the water content on temperature change of the compositions.

Equal volumes (320 cm³) of each composition was frozen to −27° C. and brought to a room temperature environment at 25° C. As a comparison, water in a plastic bag with the same volume was used as a control. The results are shown in Table 3.

TABLE 3

| | Temperature/° C. at time stated after cooling removed | | | | | | | | | | | |
|---|---|---|---|---|---|---|---|---|---|---|---|---|
| | 0 | 30 | 60 | 120 | 150 | 180 | 210 | 240 | 270 | 300 | 330 | 360 |
| Composition | mins | mins | mins | mins | mins | mins | mins | mins | mins | mins | mins | mins |
| 1 | −27 | −18 | −11 | −6.5 | −5.5 | −3.3 | −1 | 1.8 | 3 | 4 | 5 | 6 |
| 2 | −27 | −18 | −11 | −6.5 | −5.7 | −3.8 | −1 | 1.5 | 3 | 3.8 | 5 | 6 |
| 3 | −27 | −18 | −11 | −6.5 | −5.8 | −3.8 | −1.9 | 1.5 | 3 | 4 | 6 | 8 |
| 4 | −27 | −18 | −11 | −6.5 | −5 | −4 | 0 | 2 | 4 | 6 | 8 | 11 |
| 5 | −27 | −18 | −11 | −6.5 | −6 | −3 | 1 | 3 | 5 | 7 | 10 | 12 |
| 7 | −27 | −18 | −11 | −6.5 | −5.5 | −3 | 2 | 4 | 6.3 | 10 | 13 | 15 |
| 9 | −27 | −18 | −11 | −5.5 | −5.5 | −5.5 | −4 | −3 | 10 | 13 | 15 | 18 |

According to the results Compositions 1 and 2 having 5.6%-3.6% CK content stayed cooler for longer, outperforming the ice control (Composition 9). On the other hand, until 240 minutes, ice in a plastic bag stayed cooler than the rest of the seaweed-based compositions. After 240 minutes ice was completely melted and water in the plastic bag started get warmer faster than the seaweed-based compositions.

All of the compositions in accordance with the present invention performed well as a cooling block.

### Example 5—Condensation forming on the surface

In order to test the condensation forming on the surface, each ice-pack composition was brought from a cooled temperature of −4° C. environment to 25° C. environment. After 5 minutes their surfaces are cleaned with a tissue paper that has the same size and weight. Then the weight difference on the tissue paper is measured. The results are shown in Table 4:

TABLE 4

| | Condensed Water |
|---|---|
| | Weight on 64 cm² |
| | surface |
| Composition | area/weight g |
| 1 | — |
| 2 | 0.2 |
| 3 | 0.2 |
| 4 | 0.3 |
| 5 | 0.6 |
| 7 | 1.2 |
| 9 | 1 |

When frozen ice-packs brought to a warmer environment the surface of the ice-pack creates condensation. It has been tested that ice-pack composition that high CK and low water content (Composition 1) does not form condensation on its surface. Additionally ice-packs gels that have CK contents produces less condensation forming compared to Agar compositions with the same weight and water content.

The composition that has 94.4% water content and 5.6% carrageenan kappa eliminated altogether condensation forming on its surface area.

### Example 6—Compression force

Compression is applied to compositions in accordance with embodiments of the present invention until the material breaks. The results are shown in Table 5:

TABLE 5

| | Compression | Compression |
|---|---|---|
| | Force/kg | Force/kg |
| | (before being | (after cooling |
| Composition | cooled) | and thawing) |
| 1 | 10a | 10a |
| 2 | 7a | 5a |
| 3 | 6a | 4a |
| 4 | 5a | 3a |
| 5 | 4a | 2a |
| 7 | 2a | a |

The letter ‘a’ in the table denotes a relative or comparative force for Compositions 1 to 5 with respect to Composition 7.

The material composition that has higher CK content (Composition 1) is more durable compared to the lower CK (for example, Composition 5) and Agar (Composition 7). After freezing and thawing, the compositions that have higher water content, for example higher than 96.4% (Composition 3, to 5), have reduced physical integrity. Additionally, those compositions lost some water on thawing, i.e. unfrozen water started to leak from the ice-pack compositions. The ice-pack that has the highest water content (Composition 5) leaked the most amount of water.

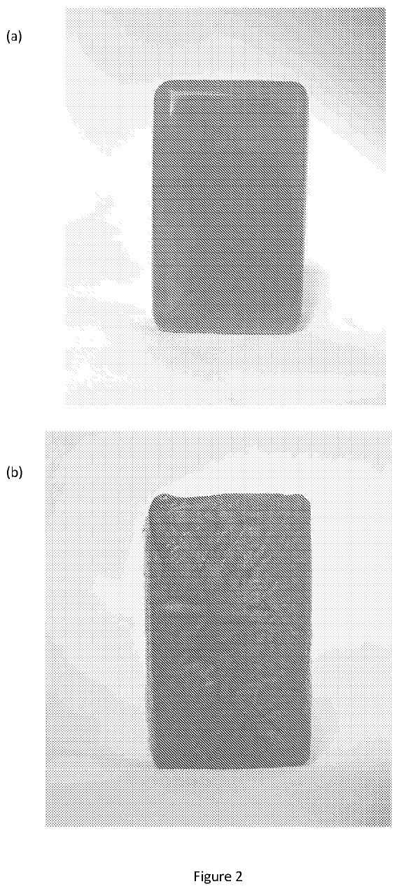

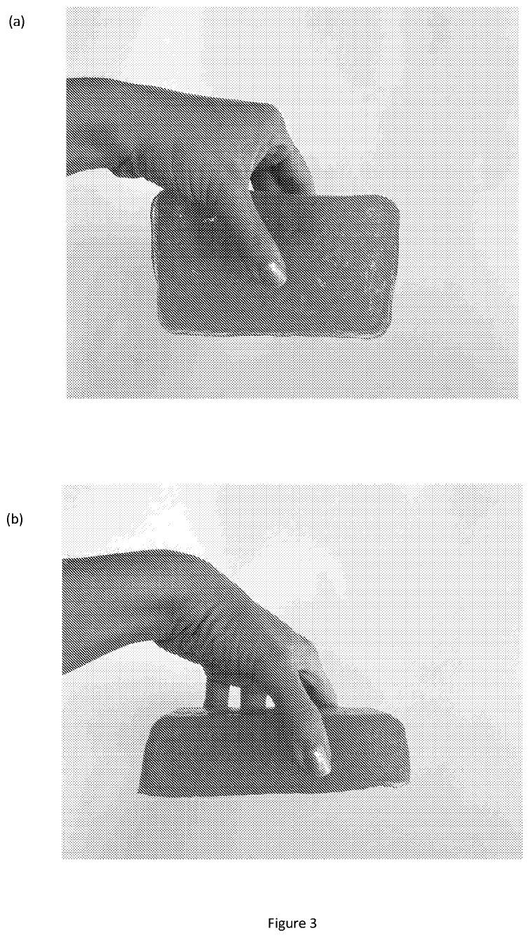

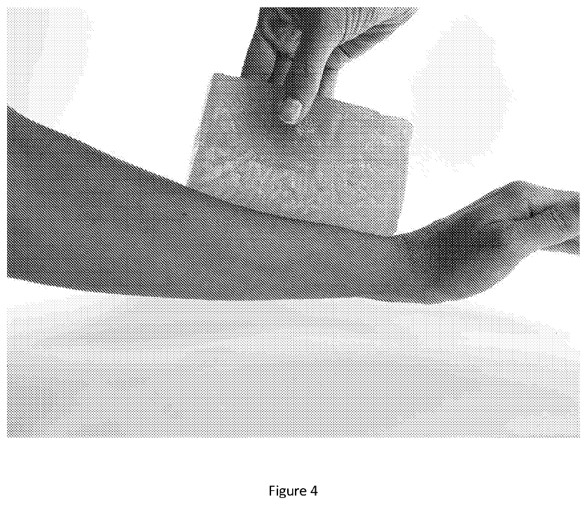

Composition 1 was moulded in to a 13.5×8.5×3.5 cm block. When standing horizontally, this moulded ice-gel block was solid, self-supporting (FIGS. 2 to 4) and could withstand a compressive force of 250 kg before breaking* at room temperature. When frozen, the water inside the solid gel block was observed to crystalise. *The compressive force was measured by placing the solid block composition at room temperature on a scale. The top surface of the ice pack was 114.75 cm² (13.5 cm×8.5 cm). A metal plate with 400 cm² (20 cm×20 cm) bottom surface is placed on top of the cool pad. Then on top of the metal surface 10 kg's of block weight is sequentially placed. With the amount of 25×10 kg of weight the cool pad didn't break however on the 26th of additional 10 kg block weight the surface of the cool pad broke signifying the limit of compressive force.

### Example 7—Transparency/Homogeneity

Compositions in accordance with the present invention were prepared as in Table 6 below. The homogeneity of each composition was recorded as was the relative transparency.

TABLE 6

| Compo- | Seaweed | | | Homo- | |
|---|---|---|---|---|---|
| sition | Extract | Weight/gr | Water/gr | geneity | Transparency |
| 1 | CK | 15 | 250 | Y | a |
| 2 | CK | 15 | 400 | Y | 2a |
| 3 | CK | 15 | 500 | Y | 3a |
| 4 | CK | 15 | 600 | Y | 4a |
| 5 | CK | 15 | 1000 | Y | 5a |
| 7 | Agar | 15 | 600 | N | N |
| 7a | Agar | 15 | 500 | N | N |
| 7b | Agar | 15 | 400 | N | N |
| 7c | Agar | 15 | 250 | N | N |

Y = a qualitative result of ‘Yes’
N = a qualitative result of ‘No’

The letter ‘a’ in the table denotes a relative or comparative transparency for Compositions 2 to with respect to Composition 1, i.e. Composition 1 to 5 become respectively more transparent as the weight percentage of water increases. All of the CK Compositions 1 to 5 showed homogeneity whereas Agar compositions 7 to 7c were unable to form a homogenous gel. The compositions that have the highest water content look more transparent than the rest of the compositions.

### Example 8—Analysis of carrageenan kappa

The carrageenan kappa used in the above examples was identified as originating from the tropical plant species Eucheuma cottonii/kappaphycus alvarezii (the two are usually treated as one in industry) using a gel press process with no added diluents.

One embodiment of the carrageenan kappa used in the exemplified examples of the invention was analysed. The general comment was that the samples was a very common, gel press type kappa, good colour and excellent clarity. A general-purpose grade rather than a specific jelly, confectionery or dairy grade.

Typical properties and comments regarding the sample used are shown in Table 7:

TABLE 7

| Test | Results and comments | | | | |
|---|---|---|---|---|---|
| Moisture | 12.64% w/w, repeat was 12.88% w/w | | | | |
| | Appears slightly too high, spec is no more than 12%. | | | | |
| Viscosity | 91 mPa · S | | | | |
| | Low for a refined carrageenan. The spec [symbol] is greater than [symbol] mPa · s so well within spec [symbol] | | | | |
| | but on the low side for a refined kappa. refined kappa grades can be over 200 mPa · S. | | | | |
| | A low viscosity also allows a higher concentration during filtration on the factory, which | | | | |
| | reduces processing costs slightly. | | | | |
| Salts | 2.6% as KCl, repeat was 2.5%. | | | | |
| | Chloride expressed as potassium chloride. Note the cations may differ, however the | | | | |
| | gel strength of the water gel suggest the salts are mainly potassium. | | | | |
| | This is typical of a gel press grade where the kappa carrageenan is gelled with | | | | |
| | potassium salts and then squeezed to remove excess water and salts. Depending on | | | | |
| | the efficiency of the pressing operation you typically see around 1-2% residual | | | | |
| | potassium chloride in the sample. Chinese confectionery grades for use in high | | | | |
| | | | | Break | Break |
| | | | 4 mm Force | Strength | Distance |
| | | Syneresis (ml) | (gms) | (gms) | (gms) |
| Gels | Salt gel | 9.8 | 196 | 807 | 10. [symbol] |
| | Salt gel | 9.7 | 217 | [symbol] 3 | 10.1 |
| | Water gel | 0 | 44.5 | 4 [symbol] 0 | 15.8 |
| | Water gel | 0 | 44.3 | 44 [symbol] | 1 [symbol] . [symbol] |

| | |
|---|---|
| | The water gels correlates with the salt analysis assumption that the salts are all |
| | potassium chloride. The water gel is low, with no syneresis and a long break distance |
| | for a kappa. The fact there is a significant gel for the water gel tells us there is residual |
| | potassium in the product which almost certainly comes from the gel press process. |
| | The salt gel is typical for medium quality grade gel pressed carrageenan. High quality |
| | grades will typically have gel strengths over 1000 gms and the very best can be over |
| | 1200 gms. These high gel grades are prized for Asian dessert jelly applications. A gel |
| | strength of 800 gms is at the low end of the spectrum and combined with the low |
| | viscosity and good colour suggest the grade is heavily bleached. |
| | Some grades contain calcium salts, these tend to raise the gels strength, reduce the |
| | break distance (harder, more brittle gel) and often leave a milky haze. This sample |
| | does not appear to have any residual calcium salts present. The slightly curved force- |
| | distance curve is typical of a potassium-kappa type gel. |
| Wash out | 11% |
| solids | This test measures the amount of material in the sample that is soluble in 60% IPA. It |
| | is used to determine if the sample has any soluble solids (salts, sugars) that are not |
| | picked up in the chloride titration. Due to the nature of the test it is a rough estimate |
| | and the complete mass balance of wash out solids, moisture and salt titration is usually |
| | only accurate to +/− ~5%. |
| | 11% wash out solids should correlate to the moisture plus the salts (which is nearer |
| | 15%) but we have assumed all salts are potassium chloride and only salts and |
| | moisture are removed by the wash. The test tells us there is probably no added |
| | diluents. |
| Clarity | Excellent. No sign of any [symbol] s or calcium induced haze. |
| | Not measured, visual. |
| Powder | L [symbol] = [symbol] 9.39, a [symbol] = −0.4 [symbol] , b [symbol] = 8.31 |
| colour | Very white product, very good colour, probably heavily bleached which may also |
| | account for the low viscosity. |

A very similar grade we have seen in the past is Andi-Johnson ® AJK-491. [symbol]
indicates data missing or illegible when filed

A typical specification for carrageenan kappa to be used in the invention are shown in Table 8:

TABLE 8

| Specification | Range |
|---|---|
| General | A refined kappa made by the gel press process using |
| | either eucheuma cottonil or kappaphycus alvarezii. |
| Moisture | Not more than 12% w/w |
| Viscosity | Greater than 60 mPa · S |
| | (This is to cut out very low viscosity grades that are |
| | sometimes used in the dairy industry, the legal |
| | spec is greater than 5 mPa · S). |
| Gel strength | Greater than 800 gms |
| | (Based on 1.2% carrageenan in 0.3% KCl at 20° C. Be |
| | careful there are many different tests used and |
| | most give a higher reading). |
| Salts | No more than 3% w/w measured as potassium chloride. |
| Powder colour | L* greater than 85 using a Minolta colour tester. |

Although particular embodiments of the invention have been disclosed herein in detail, this has been done by way of example and for the purposes of illustration only. The aforementioned embodiments are not intended to be limiting with respect to the scope of the invention. It is contemplated by the inventor that various substitutions, alterations, and modifications may be made to the invention without departing from the scope of the invention.

1. A heat-absorbing hydrogel composition comprising a seaweed extract in an amount of 1-10% by weight and water in an amount of 85-99% by weight, based on the total weight of the composition.

2. The heat-absorbing hydrogel composition of claim 1, wherein the seaweed extract in present an amount of 1.3-8% by weight and water in an amount of 85-98.7% by weight.

3. The heat-absorbing hydrogel composition of claim 1 or claim 2, wherein the composition consists essentially of the seaweed extract and water.

4. The heat-absorbing hydrogel composition of any one of claims 1 to 3, wherein the composition consists of the seaweed extract and water.

5. The heat-absorbing hydrogel composition of any one of claims 1 to 4, wherein the weight percentages of the seaweed extract and water total 100% by weight of the total weight of the composition.

6. The heat-absorbing hydrogel composition of any one of claims 1 to 5, wherein the seaweed extract is selected from the group consisting of: a carrageenan; agar; alginate; and a mixture thereof.

7. The heat-absorbing hydrogel composition of claim 6, wherein the seaweed extract is a carrageenan.

8. The heat-absorbing hydrogel composition of claim 6, wherein the carrageenan is carrageenan kappa.

9. The heat-absorbing hydrogel composition of any one of claims 1 to 8, wherein the composition is a phase change material (PCM).

10. The heat-absorbing hydrogel composition of claim 9, wherein the phase change material undergoes a phase transition at from approximately −0° C. to approximately −10° C.

11. The heat-absorbing hydrogel composition of any one of claims 1 to 10, wherein the composition is fully biodegradable.

12. The heat-absorbing hydrogel composition of claim 11, wherein the composition:
a) fully biodegrades in less than six months in an external, non-industrial environment;
b) fully biodegrades in an aerobic and/or anaerobic atmosphere; and/or
c) is fully compostable in less than six months in a domestic compost heap.

13. The heat-absorbing hydrogel composition of any one of claims 1 to 12, wherein the composition is mouldable.

14. The heat-absorbing hydrogel composition of any one of claims 1 to 13 wherein the composition further comprises one or more additives.

15. The heat-absorbing hydrogel composition of claim 14, wherein the one or more additives are present in no greater than 10% by weight of the total weight of the composition.

16. The heat-absorbing hydrogel composition of claim 14 or claim 15, wherein the one or more additives are selected from the group consisting of: salt; and glycerol.

17. The heat-absorbing hydrogel composition of claim 16 wherein the salt is selected from the group consisting of: sea salt; table salt; sodium chloride; and potassium chloride.

18. A product formed from the heat-absorbing hydrogel composition of any one of claims 1 to 17.

19. The product of claim 18, wherein the product is selected from the group consisting of: a pad; a solid block and a hollow block.

20. The product of claim 18 or claim 19, wherein the product has a working temperature of between −60° C. to 50° C.

21. The product of any one of claims 18 to 20, wherein the product has a three-dimensional self-supporting structure maintaining its shape and integrity throughout the working temperature.

22. The product of any one of claims 18 to 21, wherein the product is stable through at least one freeze-thaw cycle.

23. The product of any one of claims 18 to 22, wherein the composition has no external coating or structure formed of another material for use.

24. A method of producing the heat-absorbing hydrogel composition of any one of claims 1 to 17, the method comprising the steps of:
a) contacting the seaweed extract with water to form a seaweed extract hydrogel;
b) heating the seaweed extract hydrogel to form a hydrogel; and
c) allowing the mixture to cool in order to form the composition.

25. The method of claim 24, wherein step (a) comprises heating the mixture of the seaweed extract in water to a temperature in the range of approximately 70° C. to approximately 100° C. to form the seaweed extract hydrogel.

26. A method of producing a product of any one of claims 18 to 23, the method comprises the steps (a) to (c) of the method of producing a composition as claimed in claim 24 or claim 25, and between steps (b) and (c) the additional step of: moulding the mixture into a shape or a three-dimensional form of a product.

27. The method of claim 26, wherein the three-dimensional form encloses a space suitable for containment of liquids and/or solids.

28. The method of claim 37, wherein the space contains water.

29. A method of dissolving the composition of any one of claims 1 to 17, or the product of any one of claims 18 to 23 the method comprising the step of contacting the composition or product with liquid water.

30. The method of claim 29, wherein the liquid water is at a temperature of at least 70° C. or higher for at least 1 hour.

31. A method of industrial biodegradation of the composition of any one of claims 1 to 17, or the product of any one of claims 18 to 23, the method comprising the step of exposing the composition or product to conditions in which the rate of biodegradation is increased.

32. The method of claim 31, wherein the conditions are selected from the group consisting of: heating; exposure to water; exposure to microorganisms; enzymes; chemical breakdown; mechanical breakdown; and combinations thereof.

33. A method of composting the composition of any one of claims 1 to 17, or the product of any one of claims 18 to 23, the method comprising the step of exposing the composition or product to conditions in which the composition or product degrades to form compost or material suitable for use in compost or as an additive to soil.

34. A method of cooling an enclosed space or a surface, wherein the method comprises cooling the composition of any one of claims 1 to 17 or the product of any one of claims 18 to 23 and then placing the composition or product in the enclosed space or in contact with the surface.

35. The method of claim 34, wherein the surface is the skin of a human or animal.

36. The method of claim 34, wherein the surface is the surface of fresh produce.

37. The method of claim 34, wherein enclosed space contains fresh produce.

38. The method of claim 36 or 37, wherein the fresh produce is selected from the group consisting of: fruits; vegetables; meat and dairy products.

39. The method of any one of claims 34 to 38, wherein the composition or product is cooled to below the freezing point of the composition or product prior to use.

40. Use of the composition of any one of claims 1 to 17, or the product of any one of claims 18 to 23, as a heat-absorbing block or a heat-absorbing pad, or as a coating or case for a heat-absorbing block or a heat-absorbing pad.
